(19) United States
(12) Patent Application Publication
(10) Pub. No.: US 2017/0366042 A1
(43) Pub. Date: Dec. 21, 2017

(54) Battery Operated Appliances - Product Line five (5)

(71) Applicant: LEAH WATTS, SOUTH BEND, IN (US)

(72) Inventor: LEAH WATTS, SOUTH BEND, IN (US)

(21) Appl. No.: 14/625,610

(22) Filed: Feb. 18, 2015

(51) Int. Cl. H02J 9/06; F25B 27/00; F25D 11/00; H02S 99/00

(52) U.S. Cl. CPC H02J 9/061; H02S 99/00; F25B 27/00; F25B 27/005; F25D 11/00

(57) ABSTRACT

Refrigerator operation powers includes battery, solar, and electric. Designed for users needing energy saving appliances and users with power outages. It has at least two compartments for frozen and unfrozen food and drinks. Has retractable handle and assembled wheels to move refrigerator.

Microwave oven operation power includes battery, solar, and electric and is designed to prepare food and drinks. Designed for users with power outages or users needing energy efficient appliance. Has retractable handle and wheels to move microwave.

Cooktop grill operation power includes battery, solar, and electric. Designed to prepare food. It is designed for users who need energy saving appliance and users with power outages. Cooktop grill has at least five cooking options on top surface. Has retractable handle and at least four wheels to move cooktop grill.

Battery operated fireplace heater have three power options battery, electric, and solar. It has a retractable handle and four wheels for users to move fireplace heater. This fireplace heater is a fireplace and/or heater.

Dual blender mixer has three compartments for battery, electric, or solar power options. Dual blender mixer can prepare foods and drinks with at least two different containers.

### BACKGROUND

Refrigerators that include insulated cabinet with doors providing access to a refrigerated storage space are well known. Portable refrigerators are commonly used in homes, dorm rooms, offices, and the like, are also well known. These refrigerators may include a variety of sizes and styles. Most of these units are electrical. With power outages these units are not functional. Refrigerators don't have three power capacities of battery, electric, and solar.

### SUMMARY OF INVENTION

The present disclosure is a portable battery operated refrigerator with electrical and solar power options.

### Advantages

Provides three compartments for three power options battery, electric, and solar. Can switch from battery power to electric, or solar power. With a power surge or outage users will be able to continue use of their unit.

Has at least two compartments including freezer and compartment for unfrozen contents. Unlike most refrigerators, disclosure has easy access to freezer that is opened from the top not the front of the refrigerator.

Has unit will have at least one light inside of refrigerator and at least one light inside of freezer. Have retractable handle with at least four wheels to conveniently move unit. Can be outside of a home in places that user is seeking energy efficiency. Any and all embodiments may include variations and shape, material, construction method, size, and of invention. Embodiments not limited to portable refrigerators.

### BRIEF DESCRIPTION OF THE DRAWING

FIG. 1 is a front view of the battery operated refrigerator invention.

FIG. 2 is a front view of the battery operated refrigerator invention with doors open.

FIG. 3 is a back view of the battery operated refrigerator invention.

FIG. 4 is a top view of the battery operated refrigerator

FIG. 5 is a left side view of the battery operated refrigerator.

FIG. 6 is a right side view of the battery operated refrigerator.

FIG. 7 is s a front view of the battery operated refrigerator.

### DETAILED DESCRIPTION OF INVENTION

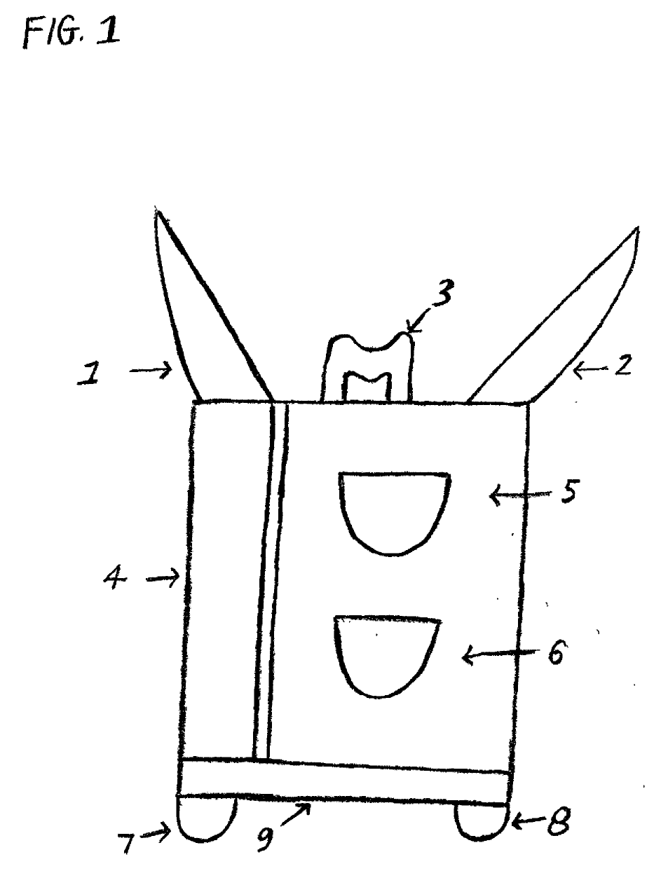

FIG. 1 shows perspective view of present invention. This shows front view of refrigerator. It shows reference numbers 1-9 with lead lines.

### Reference Numbers

1. Top of refrigerator left door of freezer

2. Top of refrigerator right door of freezer.

3. Retractable handle.

4. Front of refrigerator, left door compartment of refrigerator.

5. Front of refrigerator, top compartment door attached to right door.

6. Front of refrigerator, bottom compartment door attached to right door.

7. Left front wheel of refrigerator.

8. Right front wheel of refrigerator.

9. Bottom of refrigerator.

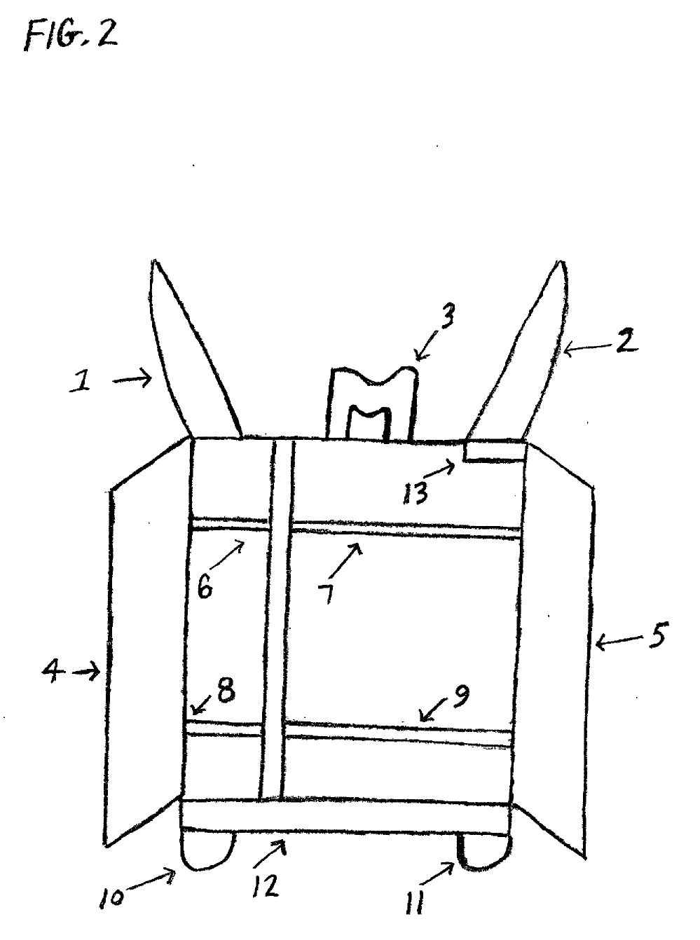

FIG. 2 shows perspective view of present invention. This shows front view of front of refrigerator with doors open. It shows reference numbers 1-13 with lead lines.

### Reference Numbers

1. Top of refrigerator left door of freezer

2. Top of refrigerator right door of freezer.

3. Retractable handle.

4. Front of refrigerator, left door of refrigerator.

5. Front of refrigerator right door open.

6. Front of refrigerator, left door inside top shelf.

7. Front of refrigerator, right side top shelf.

8. Front of refrigerator, left door inside bottom shelf.

9. Front of refrigerator, left side bottom shelf.

10. Front left wheel.

11. Front right wheel.

12. Bottom of refrigerator.

13. Light on right side of inside of refrigerator.

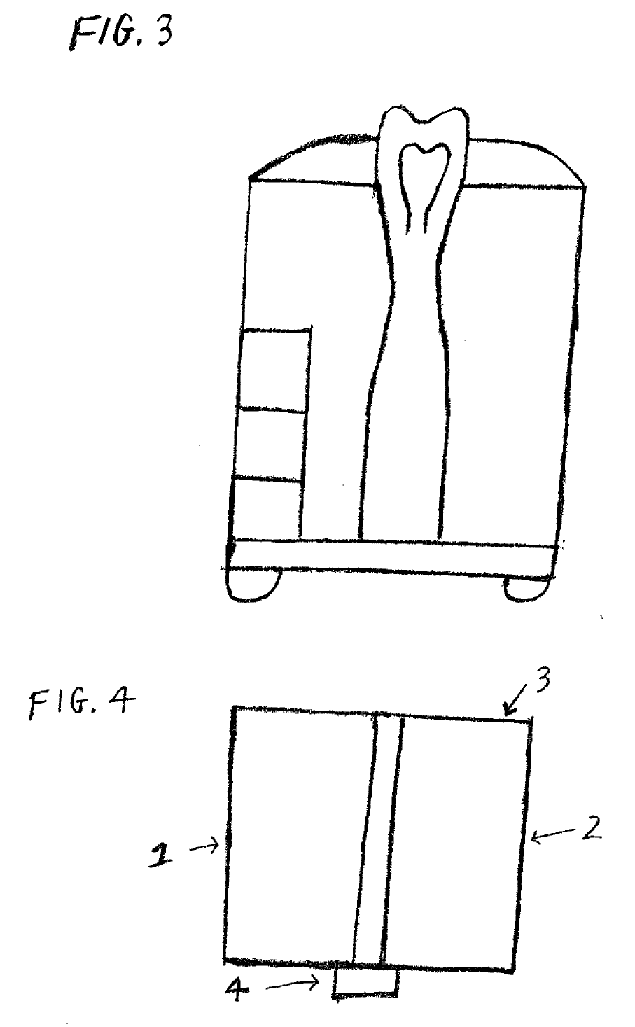

FIG. 3 shows perspective view of present invention. This shows back view of refrigerator. It shows reference numbers 1-8 with lead lines.

### Reference Numbers

1. Top of refrigerator

2. Retractable handle to pull and roll refrigerator.

3. Retractable handle.

4. Battery compartment for battery power.

5. Electric compartment for electrical power.

6. Solar compartment for solar power.

7. Right back wheel.

8. Left back wheel.

FIG. 4 shows perspective view of present invention. This shows the top of refrigerator. It shows references numbers are 1-4 with lead lines.

### Reference Numbers

1. Top of refrigerator right freezer door.

2. Top of refrigerator left freezer door.

3. Front top view of refrigerator.

4. Back top view of refrigerator retractable handle.

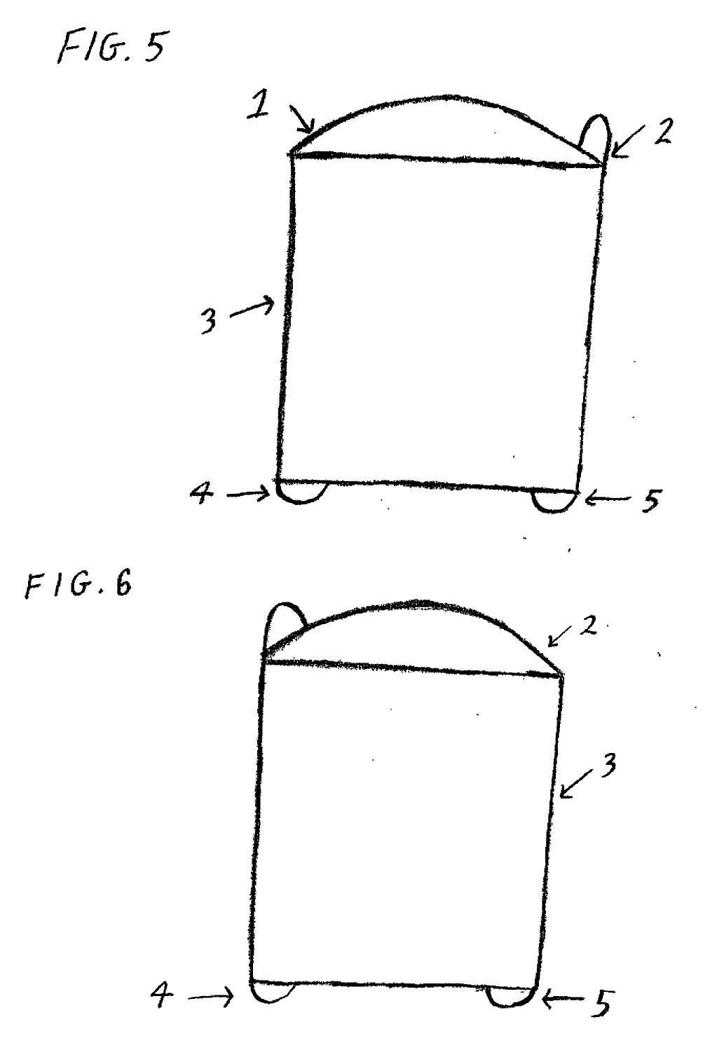

FIG. 5 shows perspective view of present invention. This shows the right side view of refrigerator. It shows references numbers are 1-5 with lead lines.

### Reference Numbers

1. Top of refrigerator right side.

2. Back of refrigerator retractable handle.

3. Front of refrigerator.

4. Right front wheel.

5. Right back wheel.

FIG. 6 shows perspective view of present invention. This shows the left side view of refrigerator. It shows references numbers are 1-5 with lead lines.

### Reference Numbers

1. Back of refrigerator and retractable handle.

2. Top of refrigerator left side view.

3. Front of refrigerator left side view.

4. Left back wheel.

5. Left front wheel.

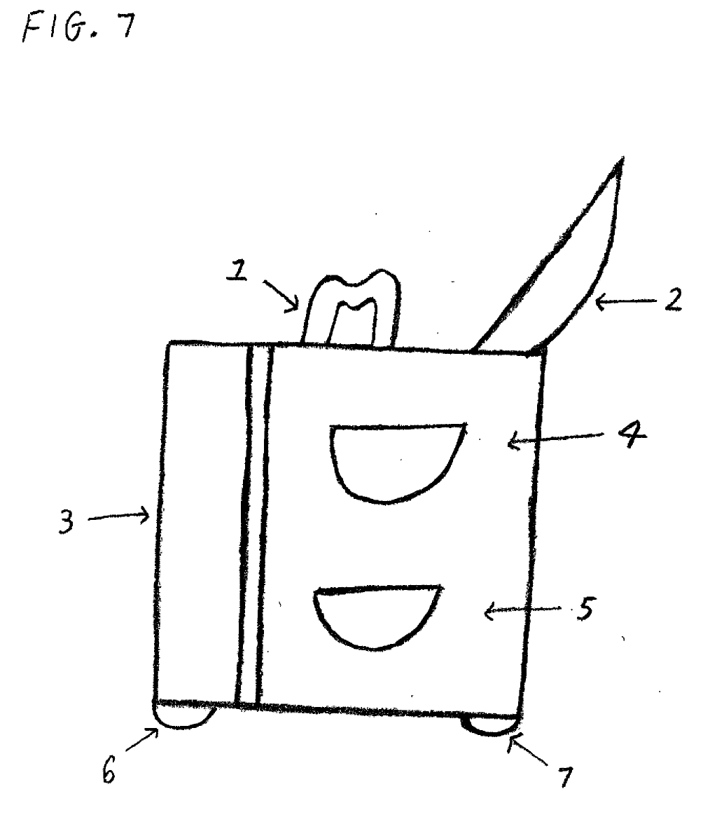

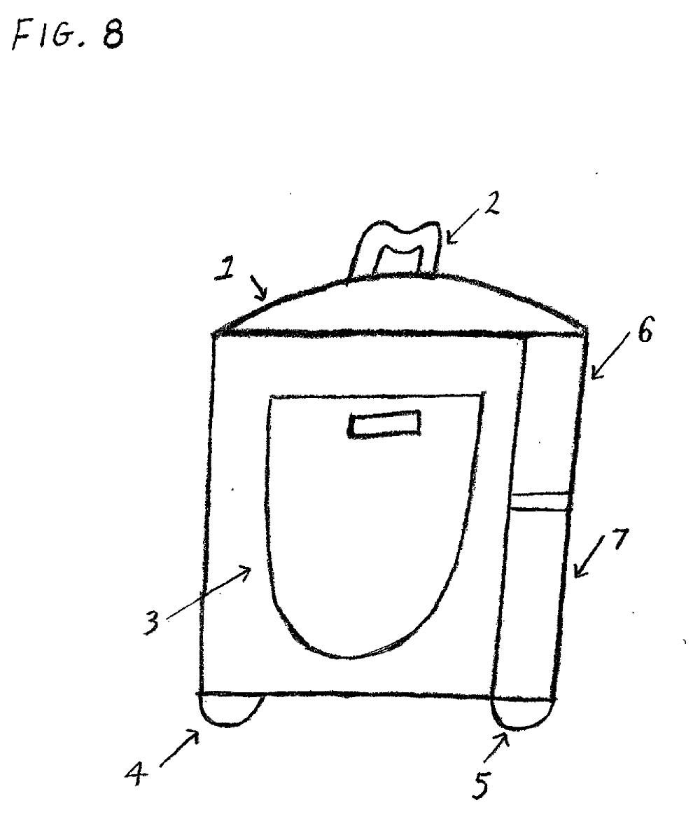

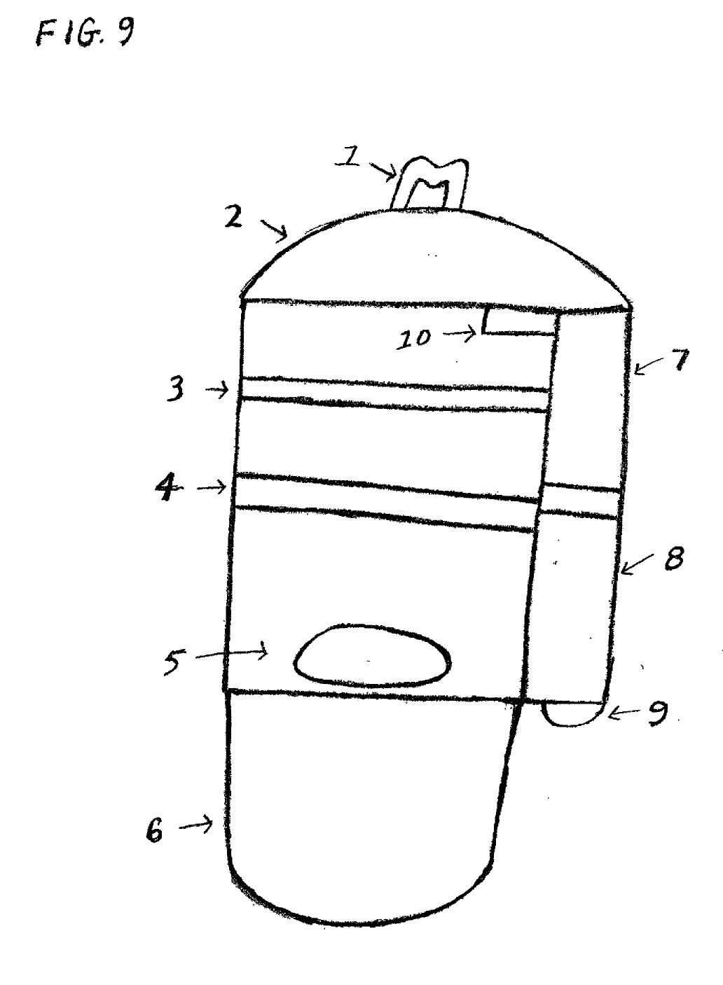

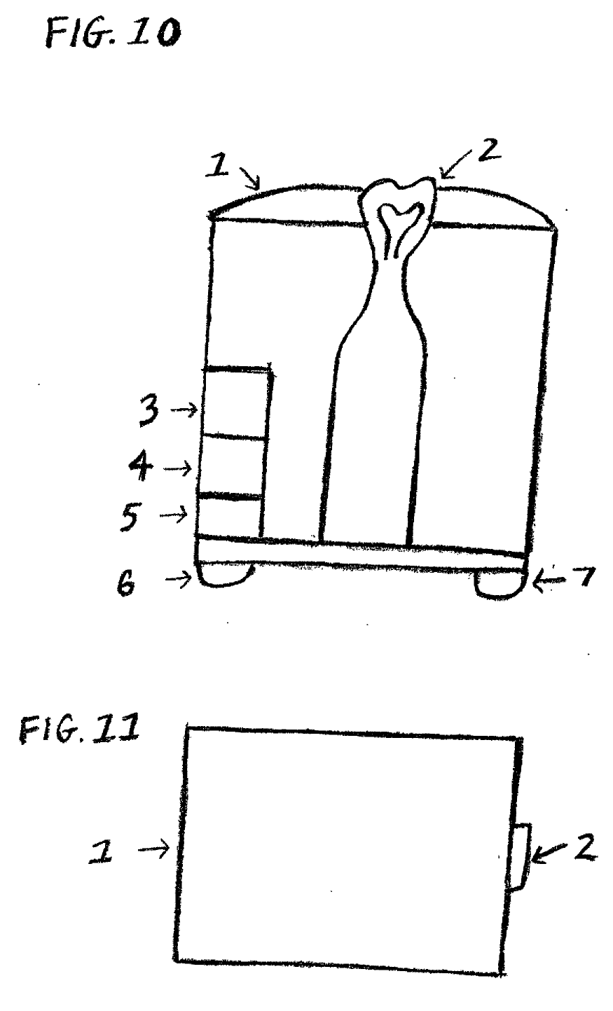

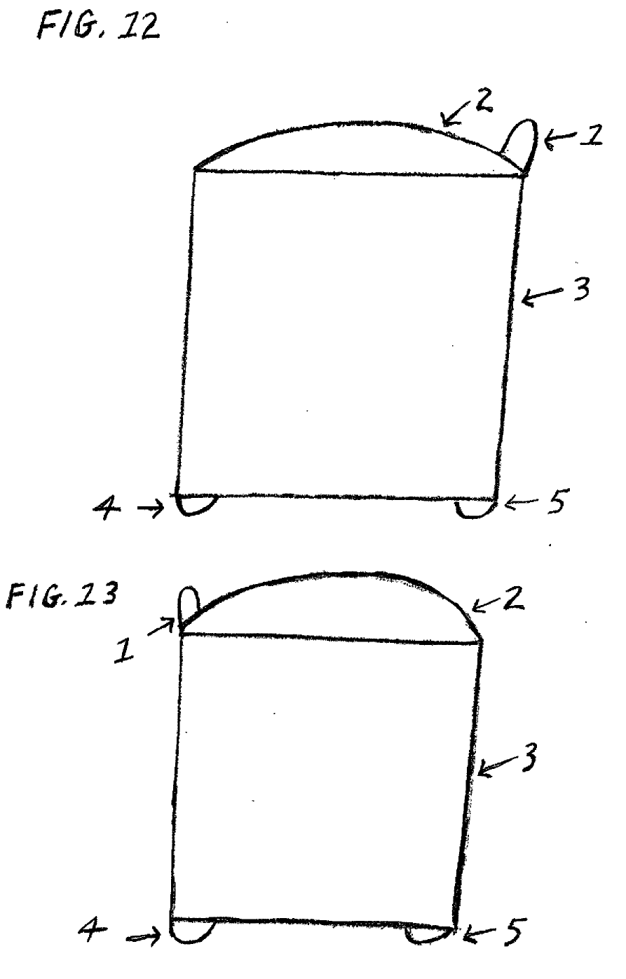

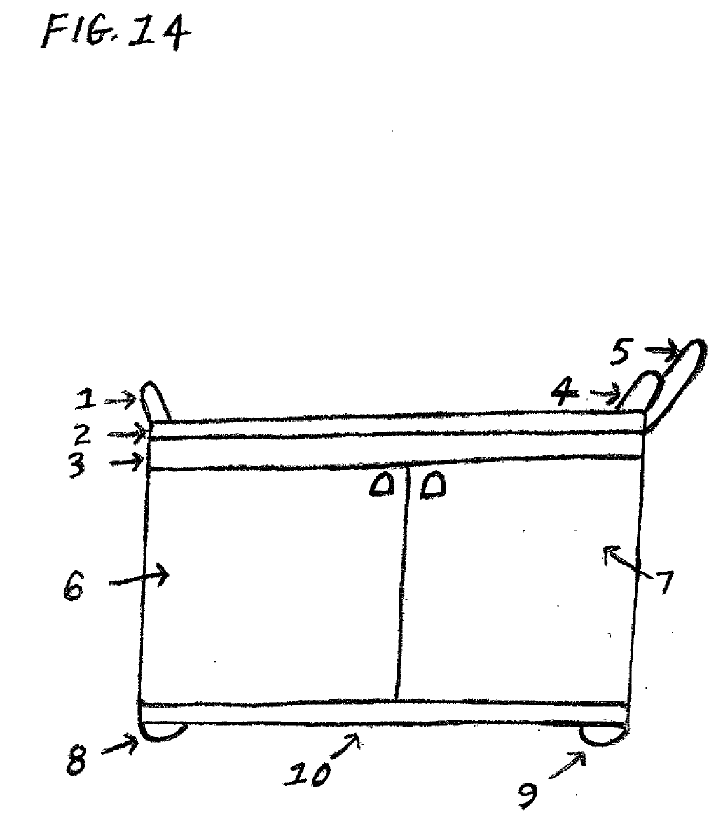

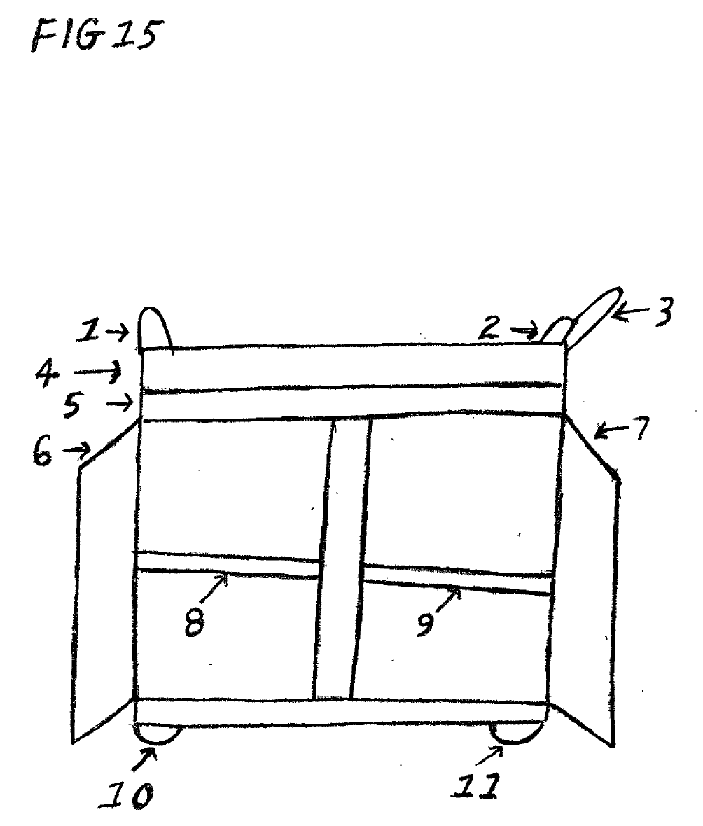

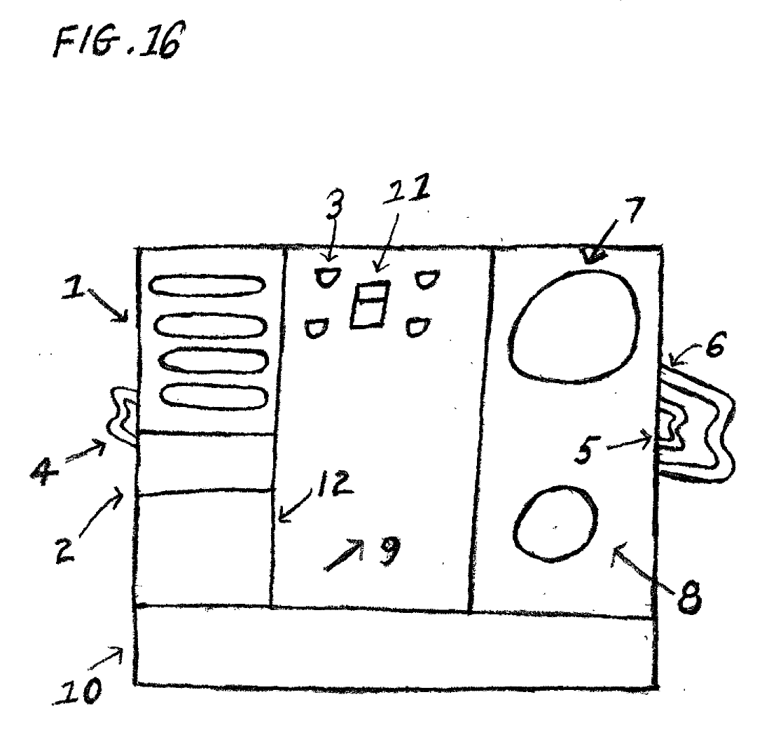

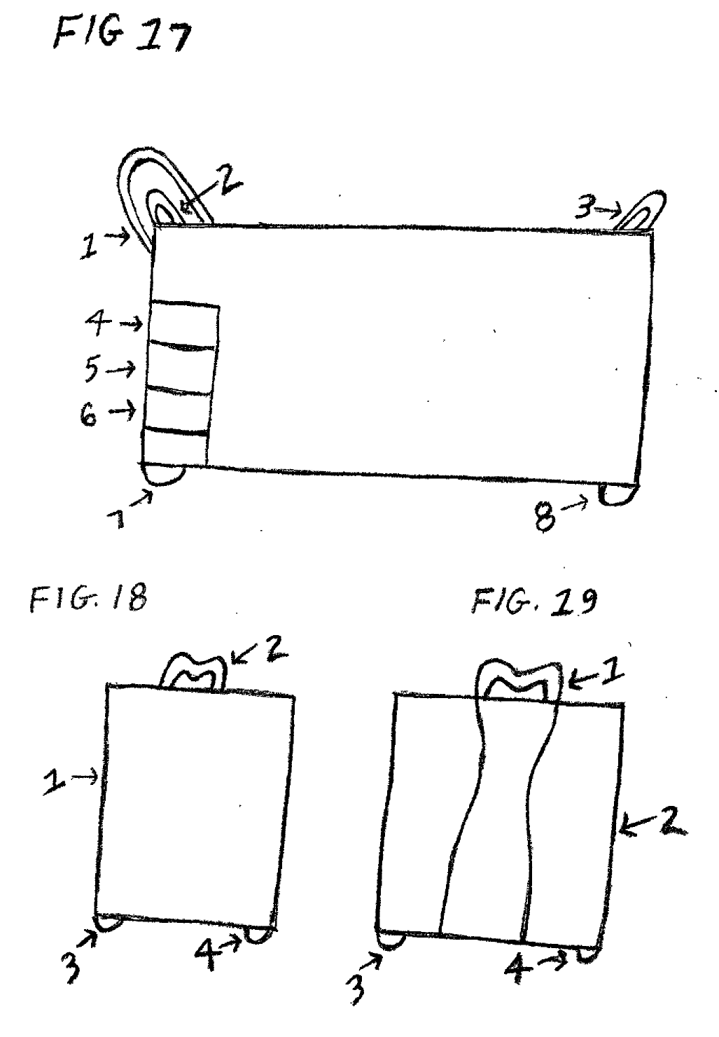

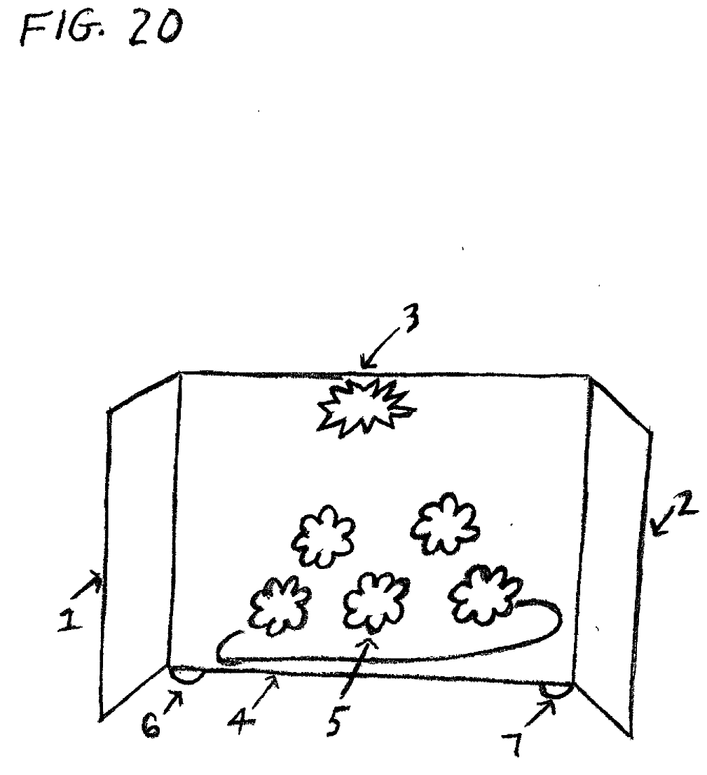

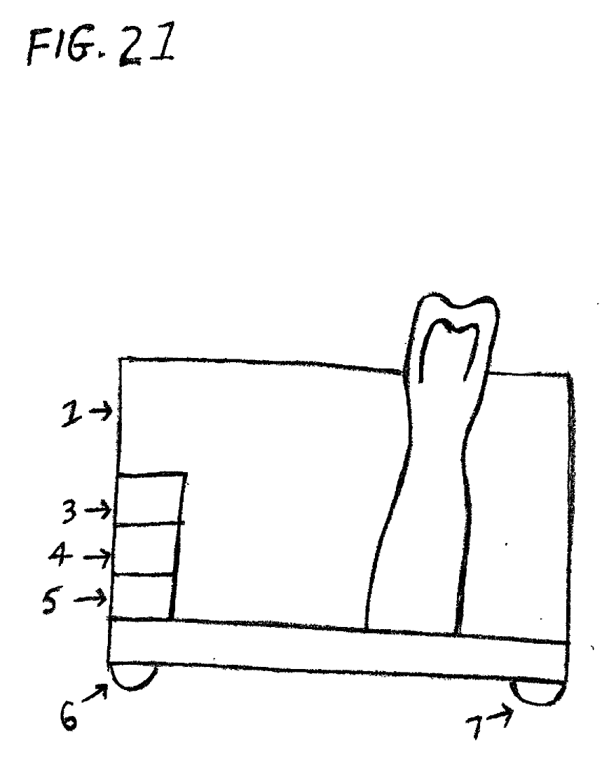

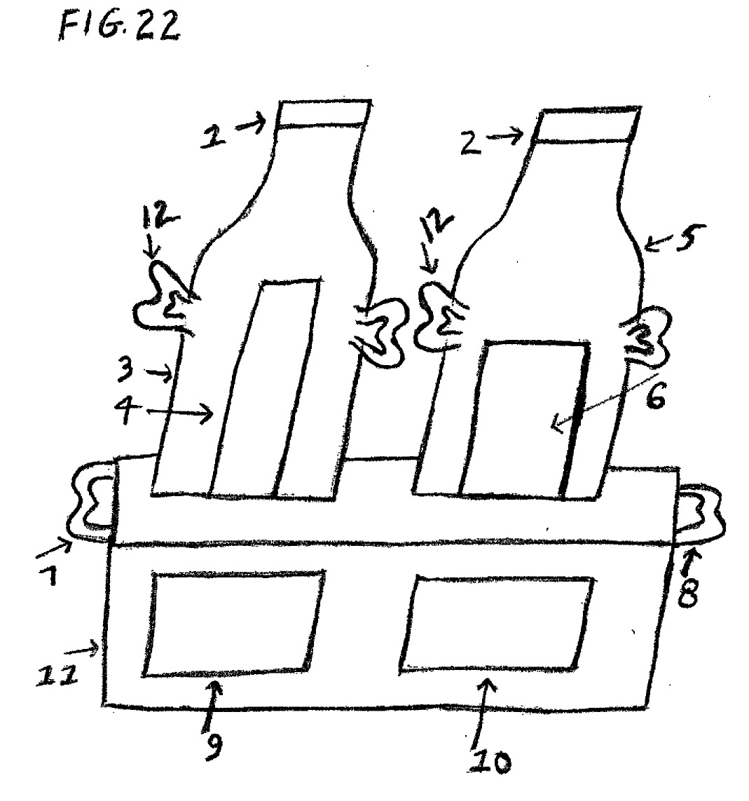

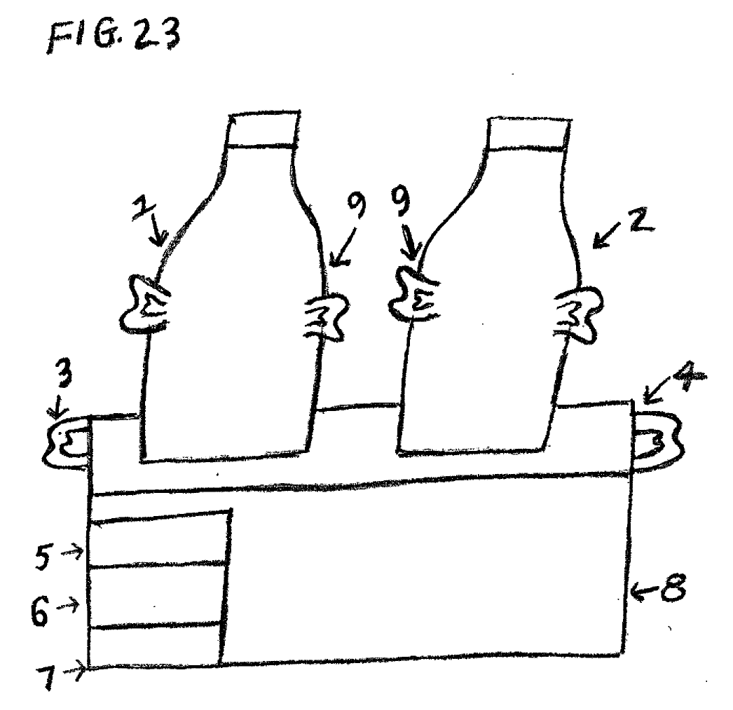

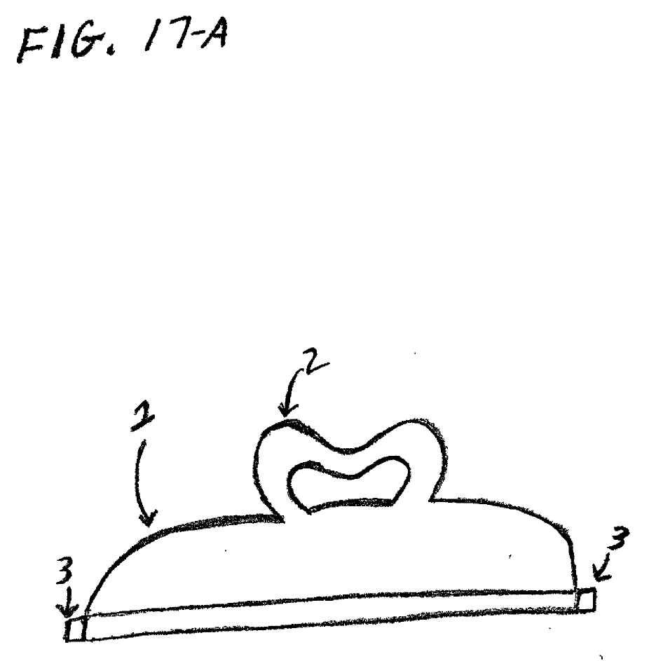

FIG. 7 shows perspective view of present invention. This shows the front of refrigerator with one freezer door. FIG. 1 has two freezer doors on top. It shows references numbers are 1-7 with lead lines.

### Reference Numbers

1. Retractable handle coming from back of refrigerator.

2. Freezer door open on top.

3. Front left door of refrigerator.

4. Top compartment attached to right door

5. Bottom compartment attached to right door.

6. Left front wheel.

7. Right front wheel.

### Background

Microwave ovens are specifically built to rapidly heat food. They are commonly used in homes, dorm rooms, offices, buildings, and other places. They may include a variety of sizes and styles. With power outages, these electrical units are not functional.

### Summary of Invention

The present disclosure is a portable battery operated microwave oven with electrical and solar power options.

### Advantages

Can be switched from battery, to electric, to solar power by user. With a power outages users will not be able to continue use of their microwave oven.

Has two control panels for operation of microwave oven. First control panel operates by touch and scroll of the options to use microwave. User is choosing to heat, defrost, cook, roast, or bake food. Second control panel is voice activated to instruct the use of microwave by using voice activation feature. For example is cook for 5 minutes. This voice activation feature will be helpful to blind users.

Has an oven style door in front, opened from the top. Has at least two shelves inside for multiple items to be microwaved at the same time and the top of microwave oven is dome shaped to increase and give extra space inside.

Provide options to use turntable and several shelves for preparing more than one food and drink items at the same time.

Outside this microwave oven has a retractable handle and wheels for convenient movement of microwave from one location to another. User has three options, battery, electric, or solar power.

Any and all embodiments may include variations in shape, material, construction method use, and size of invention.

### Brief Description of the Drawing

FIG. 8 is a front view of the portable battery operated microwave oven invention.

FIG. 9 is a front view of the portable battery operated microwave oven invention with door open.

FIG. 10 is a back view of the portable battery operated microwave oven invention.

FIG. 11 is a top view of the portable battery operated microwave oven invention.

FIG. 12 is a right side view of the portable battery operated microwave oven invention.

FIG. 13 is a left side view of the portable battery operated microwave oven invention.

### Detailed Description of Invention

FIG. 8 shows perspective view of present invention. This shows front view of portable battery operated microwave oven. It shows reference numbers 1-7

### Reference Numbers

1. Top of portable battery operated microwave oven.

2. Retractable handle.

3. Oven style door pulled from top to bottom.

4. Left front wheel of portable battery operated microwave oven.

5. Right front wheel of portable battery operated microwave oven.

6. Top panel for touch tone hand swipe scroll pad for users.

7. Bottom panel for voice activated pad for users.

FIG. 9 shows perspective view of present invention. This shows front view of front of portable battery operated microwave oven. It shows reference numbers 1-10 with lead lines.

### Reference Numbers

1. Retractable handle

2. Top of microwave oven.

3. Inside of microwave oven top shelf

4. Inside of microwave oven bottom shelf

5. Turntable

6. Microwave oven door open.

7. Top panel for touch tone hand swipe scroll panel.

8. Bottom panel for voice activated operation for users.

9. Front right wheel

10. Light system in microwave oven.

FIG. 10 shows perspective view of present invention. This shows back view of portable battery operated microwave oven. It shows reference numbers 1-7.

### Reference Numbers

1. Top of microwave oven.

2. Retractable handle.

3. Compartment for battery power

4. Compartment for electrical power

5. Compartment for solar power

6. Back right wheel

7. Back left wheel.

FIG. 11 shows perspective view of present invention. This shows the top of portable battery operated microwave oven. It shows references numbers 1-2.

### Reference Numbers

1. Top front of microwave oven

2. Top back of microwave oven with retractable handle illustrated.

FIG. 12 shows perspective view of present invention. This shows the right side view of portable battery operated microwave oven. It shows references numbers 1-5 with lead lines.

### Reference Numbers

1. Back of microwave oven illustrating retractable handle

2. Top of microwave oven

3. Right side view of microwave oven

4. Front right wheel.

5. Back right wheel.

FIG. 13 shows perspective view of present invention. This shows the left side view of portable battery operated microwave oven. It shows references numbers are 1-5 with lead lines.

### Reference Numbers

1. Back of microwave oven illustrating retractable handle.

2. Top of microwave oven.

3. Front of microwave oven left side view.

4. Back left wheel.

5. Front left wheel.

### Background

The present disclosure is a portable battery operated cooktop grill with battery, electric, and solar power options. Cooktops are known to cook food without complete oven. Cooktops are commonly in homes, businesses, and offices. These cooktops may include a variety of sizes and styles. Most of these units are electrical or gas. With power outages these units are not functional.

### Summary of Invention

The present disclosure provides a portable battery operated cooktop grill with battery, electrical, and solar power compartments.

### Advantages

These three sources of power is an advantage to users who may have power outages. At least four featured cooking options with surfaces for grill, fry, broil or food and drinks. It has a multiple prong riveted grill, smooth surface grill, fryer, and two burners.

Control panel has at least one light system on top of cooktop grill. The control panel has at least three heating and temperature options including low, medium, and high heat; and options of use of riveted grill, flat surface grill, fryer, or one of burners small or large.

A retractable handle and wheels to roll unit to different locations. A retractable serving table to serve food and drinks. It has two doors in front with shelf space under unit.

Cooktop can be used inside building or outside of building. It is not restricted to kitchen space. Any and all embodiments may include variations in shape, material, construction method, use, and size of invention.

### Brief Description of the Drawing

FIG. 14 is a front view of the portable battery operated cooktop grill invention.

FIG. 15 is a front view of the portable battery operated cooktop grill with doors open.

FIG. 16 is a top view of the portable battery operated cooktop grill invention.

FIG. 17 is a back view of the portable battery operated cooktop grill invention.

FIG. 17A is a view of the portable battery operated cooktop grill cover (top).

FIG. 18 is a left side view of the portable battery operated cooktop grill.

FIG. 19 is a right side view of the portable battery operated cooktop grill.

### Detailed Description of Invention

FIG. 14 shows perspective view of present invention. This shows front view of front of portable battery operated cooktop grill. It shows reference numbers 1-10 with lead lines.

### Reference Numbers

1. Left side handle.

2. Cooking surface front view.

3. Retractable serving table

4. Right side handle.

5. Retractable handle for rolling unit.

6. Front left door

7. Front right door

8. Front left wheel

9. Front right wheel

10. Bottom of cooktop grill.

FIG. 15 shows perspective view of present invention. This shows front view of front of battery operated cooktop grill with doors open. It shows reference numbers 1-11 with lead lines.

### Reference Numbers

1. Left side handle.

2. Right side handle.

3. Retractable handle.

4. Cooking surface front view.

5. Retractable serving table.

6. Left door open.

7. Right door open.

8. Inside left door shelf

9. Inside right door shelf

10. Left front wheel.

11. Right front wheel.

FIG. 16 shows perspective view of present invention. This shows top view of portable battery operated cooktop grill. It shows reference numbers 1-12 with lead lines.

### Reference Numbers

1. At least four rivets for grill surface

2. Flat surface grill and fryer surface

3. Four buttons for at least four surfaces on cooktop

4. Left handle

5. Right handle

6. Retractable handle

7. Large cooktop electric burner

8. Small cooktop electric burner

9. Serving space

10. Retractable serving table.

11. Light system pad with on/off button included.

12. Fryer with basket for fryer oil.

FIG. 17 shows perspective view of present invention. Shows back view of portable battery operated cooktop grill. Showing reference numbers 1-8 with lead lines.

### Reference Numbers

1. Retractable handle

2. Right handle.

3. Left handle.

4. Compartment for battery power

5. Compartment for electric power

6. Compartment for solar power.

7. Right back wheel

8. Left back wheel.

FIG. 17-A shows perspective view of cooktop grill cover (top). It shows the front view of the cooktop grill cover. The back view of cooktop grill cover is identical to the front view. It shows references 1-4 with lead lines.

### Reference Numbers

1. Detachable top for cooktop grill

2. Handle of cooktop grill

3. Locking mechanism right

4. Locking mechanism left

FIG. 18 shows perspective view of present invention. This shows front view of left side of portable battery operated cooktop grill. Shows reference numbers 1-4 with lead lines

### Reference Numbers

1. Left side of cooktop grill.

2. Left side of cooktop grill.

3. Left back wheel.

4. Left front wheel.

FIG. 19 shows perspective view of present invention. This shows right side of portable battery operated cooktop grill. It shows reference numbers 1-4 with lead lines.

### Reference Numbers

1. Retractable handle

2. Right side of cooktop grill illustrating back side with lead line.

3. Right front wheel.

4. Right back wheel.

### Background

Fireplaces are known in homes, offices, and wider variety of places inside and outside of buildings. The fireplaces can simulate fire flames to look like real fire. At the same time, it is a heating source used to warm and heat dwelling space for users. These fireplaces may include a variety of sizes and styles. Most of these units are electrical or gas. With power outages these units are not functional.

### Summary of Invention

The present disclosure is a portable battery operated fireplace heater can be switched from battery, to electric, to solar power.

### Advantages

Has at least three compartments with on/off switch, battery, electric, and solar power for energy efficiency.

Heating source with simulated snowflakes and heating elements powered all three power sources battery, electric, and solar.

Fireplace heater includes light and heating element at ceiling of fireplace heater. Has a retractable handle and at least four wheels to transport unit to different locations. In front of fireplace heater are two glass doors.

Fireplace heater is not restricted to indoor spaces. Any and all embodiments may include variations in shape, material, construction method, use, and size of invention. Embodiments are not limited fireplace heaters. Embodiments can be fireplace or heater.

### Brief Description of the Drawing

FIG. 20 is a front view of the portable battery operated fireplace heater invention.

FIG. 21 is a back view of the portable battery operated fireplace heater invention.

FIG. 22 is a is a front view of a portable battery operated dual blender mixer invention.

FIG. 23 is a back view of a portable battery operated dual blender mixer invention.

### Detailed Description of Invention

FIG. 20 shows perspective view of present invention. This shows front view of portable battery operated fireplace heater. It shows reference numbers 1-7 with lead lines.

### Reference Numbers

1. Left door open.

2. Right door open.

3. Top of unit with ceiling light and heating element.

4. Heating element bed

5. Simulated snowflake flames

6. Front left wheel

7. Front right wheel.

FIG. 21 shows perspective view of present invention. This shows back of portable battery operated fireplace heater. It shows reference numbers 1-7 with lead lines.

### Reference Numbers

1. Back right side of unit.

2. Retractable handle

3. Battery power compartment

4. Electric power compartment

5. Solar power compartment.

6. Back left wheel

7. Back right wheel.

### Background

Blenders and mixers are known in homes, offices, and wider variety of places. The blenders and mixer are used to change complexion of foods and drinks. These blenders and mixers may include a variety of sizes and styles. Most of these units are electrical. With power outages these units are not functional.

### Summary of Invention

The present invention is a portable battery operated dual blender-mixer that can be switched from battery, to electric, or solar power by user.

### Advantages

Three power options and compartments including battery, electric, and solar and can be operated during power outages. It is a dual unit that is both blender and mixer as opposed to two separate units.

Has two control panels with plurality of uses for food and drinks as well as baking. The Control panel has options to blend drinks and food. The blender blends, chop, and Crush and the mixer mix, mesh, and stir food for cooking and baking.

Handles for housing of containers and handles for containers for easy handle and care. Blender mixer is not restricted to kitchen spaces.

Any and all embodiments may include variations in shape, material, construction method, use, and size of invention. Not restricted to kitchens and inside of buildings.

FIG. 22 shows perspective view of present invention. This shows front side of a portable battery operated dual blender mixer. It shows reference numbers 1-11 with lead lines.

### Reference Numbers

1. Front view left side illustrates first part of dual unit which illustrates blender.

2. Front view right side illustrates second part of dual unit which illustrates mixer.

3. Side view of blender.

4. Blender blades compartment

5. Side view of mixer.

6. Mixer blades compartment

7. Left handle

8. Right handle

9. Control panel for blender

10. Control panel for mixer

11. Front side of housing for blender and mixer

FIG. 23 shows perspective view of present invention. This shows back side of portable battery operated dual blender mixer. It shows reference numbers 1-9 with lead lines.

### Reference Numbers

1. Back side mixer.

2. Back side blender

3. Right handle

4. Left handle.

5. Battery power compartment.

6. Electric power compartment.

7. Solar power compartment

8. Back side of housing for blender and mixer

9. Pairs of handles for both mixer and blender

What is claimed is:

1. A battery operated refrigerator comprising: a refrigerator body; at least one control compartment for battery, electric, and solar power operation; power selections for each power operation; at least one storage compartment; at least one door to at least one compartment; at least one insulated upper compartment for freezer and lower compartments for unfrozen contents; retractable handle; at least four lockable wheels; at least one door directly on top of refrigerator for entry into freezer; at least one dome shaped door directly on top of refrigerator for entry into freezer; at least two doors in front of refrigerator of lower compartments to refrigerator; least one light in freezer upper compartment and at least one light in lower level refrigerator compartment; at least one removable shelf inside of refrigerator compartments.

2. The refrigerator of claim 1 wherein the body comprises at least four walls front, top, bottom, right and left sides.

3. The refrigerator of claim 1 wherein normal controls attached to body to adjust freezer and refrigerator to normal temperatures.

4. The refrigerator of claim 1 wherein mechanical parts including compressor, evaporator, condenser, condenser parts, defroster, thermostat, expansion valve, fan, refrigerant.

5. A refrigerator of claim 1 wherein embodiments are not limited to portable appliances and any and all embodiments may include variations of shape, material, construction method, use, and size of invention.

1. A battery operated microwave oven comprising: a body; at least one control compartment for battery, electric, and solar power; power settings for each power selection inside of power compartment; at least two control panels; one control panel has touch screen which is touch an scroll and one control panel is voice activated with touch option; at least four wheels on body; retractable handle; oven style door in front of oven pull down from top to bottom; dome shaped top for increased and extra space; at least one shelf inside of body; at least one turntable inside of body.

2. The microwave of claim 1 wherein mechanical components including transformer, converter, capacitor, cavity magnetron, control circuit, microwave guide, and cooking chamber.

3. The microwave of claim 1 comprised of at least four walls, two sides, top, back, and bottom cavity of microwave.

4. The microwave of claim 1 wherein a control panel with touch tone screen that will allow user to scroll screen to proper setting to cook, bake, heat, thaw, warm, roast.

5. The microwave of claim 1 wherein a control panel with voice activated screen for user to speak operation method needed to prepare food and drinks; user will speak method of preparation and choose amount of time microwave will prepare method, example is cook for five minutes.

6. The microwave of claim 1 wherein embodiments are not limited to portable appliances and any and all embodiments may include variations of shape, material, construction method, use, and size of invention

1. A battery operated cooktop grill comprising: a body; cooking appliance top surface; compartment for three power sources battery, electric, and solar; power settings in compartment for power options; switch for powers to turn on and off; plurality of cooking sections on top including at least five prong riveted grill surface, flat grill surface, fryer, and two burners one small and one large; a cooking control panel with heating and temperature options power settings for on and off; temperature options low, medium, high, grill, fry, broil, cook; retractable serving table; retractable handle; at least four lockable wheels; detachable top to protect cooktop grill; at least one light on top right side of cooktop grill; at least two shelves inside underneath cooktop grill at least two doors in front below cooktop grill.

2. The cooktop grill of claim 1 wherein normal mechanical parts for cooktop grill

3. The cooktop grill of claim 1 where in normal engineering parts for cooktop grill.

4. The cooktop grill of claim 1 wherein embodiments are not limited to portable appliances and any and all embodiments may include variations of shape, material, construction method, use, and size of invention

1. A battery operated fireplace heater comprising: at least three compartments with power options of battery, electric, and solar; at least three temperature options of low, medium, and high heat, with on/off option; retractable handle; at least four wheels to move unit; compartment for snowflakes heating elements and heating bed; at least one ceiling light; at least one ceiling heating element; at least one glass door in front of fireplace heater; fireplace heater can be fireplace and/or heater.

2. The fireplace heater of claim 1 wherein back wall, side walls, top wall, and bottom wall.

3. The fireplace heater of claim 1 wherein any material doors in front of fireplace heater.

4. The battery operated fireplace heater of claim 1 wherein any and all embodiments may include variations in shape, material, construction method, use, and size of invention and not restricted to inside of building.

5. The fireplace heater of claim 1 wherein normal engineering parts for fireplace heater.

6. The fireplace heater of claim 1 wherein normal mechanical parts of fireplace heater.

1. A battery operated dual blender mixer comprising: three compartments for power of battery, electric, and solar; dual feature including blender and mixer; at least two containers to blend and mix food and drinks; at least one blending blade for blending container; at least one blade for mixer container; housing for blender and mixer; control panel for mixer options to mix, mesh, stir with mixer options of low, medium, high speeds; control panel for blender options to blend, chop, crush with blender options of low, medium, and high speeds; at least one handle on both right and left sides of housing for easy lift up; back, front, top, right and left sides, and bottom for dual blender mixer.

2. A battery operated dual blender mixer of claim 1 wherein normal operation mechanical components.

3. A battery operated dual blender mixer of claim 1 wherein normal operation engineering components.

4. A battery operated dual blender mixer of claim 1 wherein any and all embodiments may include variations in shape, material, construction method, use, and size of invention.
